(19) United States
(12) Patent Application Publication
(10) Pub. No.: US 2025/0072646 A1
(43) Pub. Date: Mar. 6, 2025

(54) COOKING APPARATUS

(71) Applicant: SHENZHEN TYPHUR TECHNOLOGY CO., LTD, Shenzhen (CN)

(72) Inventors: Xiangmin Tan, Shenzhen (CN); Linhuan Wang, Shenzhen (CN); Keneng Liu, Shenzhen (CN); Qi Liang, Shenzhen (CN)

(21) Appl. No.: 18/950,213

(22) Filed: Nov. 18, 2024

Related U.S. Application Data
(63) Continuation of application No. PCT/CN2022/093710, filed on May 18, 2022.

(51) Int. Cl. A47J 27/10

(52) U.S. Cl. CPC A47J 27/10

(57) ABSTRACT

A cooking apparatus (10), comprising a host (60) and a container (50), wherein the host (60) is arranged outside the container (50), and the host (60) and the container (50) are arranged in parallel on a placement plane. Therefore, the overall stability of the cooking apparatus (10) can be effectively improved, and the container (50) and the host (60) can be prevented from shaking and tilting.

### CROSS REFERENCE TO RELATED APPLICATIONS

The present application is a Continuation Application of PCT Application No. PCT/CN2022/093710 filed on May 18, 2022, the contents of which are incorporated herein by reference in their entirety.

### TECHNICAL FIELD

This specification relates to the technical field of cooking apparatuses, particularly to a cooking apparatus.

### BACKGROUND

A sous-vide cooker is a device that uses low-temperature cooking technology to cook ingredients. During actual use, ingredients can be placed in a vacuum bag, which is then placed in a container of liquid at a specific temperature (For instant, below 100° C.) for a set time to perform low-temperature cooking. However, during the development, the inventors found that existing cooking apparatuses have at least the following problems: poor stability after the container and the host are connected, and limitations on the size of the display screen on the host, which affects the user experience.

This specification aims to provide a cooking apparatus that effectively enhances the overall stability of the cooking equipment, prevents the container and the host from shaking or toppling, and makes it easier to set a larger display screen on the host to improve the user experience.

### SUMMARY

Some embodiments of this specification provide a cooking apparatus comprising a host and a container; the host is placed outside the container, and both are arranged side by side on a flat surface.

Some embodiments of this specification provide a cooking apparatus comprising a host and a container; the host is placed outside the container, and the bottom surfaces of both the host and the container are in contact with the flat surface.

### DESCRIPTION OF DRAWINGS

This specification will further illustrate exemplary embodiments that will be described in detail with reference to the drawings. These exemplary embodiments are not limiting; in these embodiments, the same numbers indicate similar structures:

FIG. 1 is a schematic diagram of modules of the cooking apparatus according to some embodiments of this specification;

FIG. 2 is a schematic diagram of modules of the liquid circulation system according to some embodiments;

FIG. 3 is a flowchart illustrating the installation of the cooking apparatus according to some embodiments;

FIG. 4 is a schematic structural diagram of the cooking apparatus according to other embodiments;

FIG. 5 is a side view of the cooking apparatus shown in FIG. 4;

FIG. 6 is a front view of the cooking apparatus shown in FIG. 4;

FIG. 7 is a schematic structural diagram of the connection between the container and the liquid inlet and outlet component according to some embodiments;

FIG. 8 is a schematic structural diagram of the container connecter according to some embodiments;

FIG. 9 is a schematic structural diagram of the host connecter according to some embodiments;

FIG. 10 is a schematic structural diagram of the joint cover assembly according to some embodiments;

FIG. 11 is a schematic structural diagram of the connection between the container and the liquid inlet/outlet components according to other embodiments;

FIG. 12 is a cross-sectional view of the liquid inlet and outlet component shown in FIG. 11;

FIG. 13 is a schematic structural diagram of the host pipe assembly according to some embodiments;

FIG. 14 is a schematic structural diagram of the second liquid inlet pipe and the second liquid outlet pipe according to some embodiments.

### DETAILED DESCRIPTION

In order to clearly illustrate the technical solutions of the embodiments of this specification, a brief introduction of the drawings used in the embodiment description is provided below. It is apparent that the drawings described below are merely some examples or embodiments of this specification. To those skilled in the art, this specification can also be applied to other similar situations without any creative effort. It should be understood that these exemplary embodiments are provided merely to help those skilled in the relevant field better understand and implement the invention, and are not intended to limit the scope of the invention in any way. Unless otherwise apparent from the context or otherwise stated, the same reference numerals in the figures represent the same structure or operation.

The terminology used in the descriptions of various embodiments of the cooking apparatus herein is intended to describe specific embodiments and is not intended to limit the invention. As used in the descriptions of various embodiments and the appended claims, the singular forms “a” and “the” are intended to include the plural forms as well, unless the context clearly indicates otherwise. It will also be understood that the term “and/or” as used herein refers to and includes any and all possible combinations of one or more of the associated listed items. It will also be understood that the term “comprises” as used in this specification indicates the presence of stated features, steps, operations, elements, and/or components, but does not exclude the presence or addition of one or more other features, steps, operations, elements, and/or components.

The following provides detailed references to embodiments, examples of which are shown in the accompanying drawings. Numerous specific details are set forth in the following detailed description to provide a thorough understanding of the various embodiments described. However, those skilled in the art should understand that the various embodiments described herein can be practiced without these specific details. In other embodiments, well-known methods, processes, components, circuits, and networks are not described in detail to avoid unnecessarily obscuring the embodiments.

The terminology used in the descriptions of various embodiments herein is intended to describe specific embodiments and is not intended to limit the invention. As used in the descriptions of various embodiments and the appended claims, the singular forms “a” and “the” are intended to include the plural forms as well, unless the context clearly indicates otherwise. It will also be understood that the term “and/or” as used herein refers to and includes any and all possible combinations of one or more of the associated listed items. It will also be understood that the term “comprises” as used in this specification indicates the presence of stated features, steps, operations, elements, and/or components, but does not exclude the presence or addition of one or more other features, steps, operations, elements, and/or components.

As used herein, depending on the context, the term “if” can be interpreted to mean “when,” “in response to determining,” or “in response to detecting,” etc. Similarly, depending on the context, the phrase “if it is determined . . . ” or “if it is detected [the stated condition or event]” can be interpreted to mean “upon determining . . . ,” “in response to determining . . . ,” “upon detecting [the stated condition or event],” or “in response to detecting [the stated condition or event].”

In some embodiments, the cooking apparatus may include a container and a host located below the container. The bottom of the container has an inlet and an outlet, which are connected to the pipes in the host. The liquid in the container flows into the pipes on the side of the host by gravity. In some cases, since the inlet and outlet of the container are located at the bottom, when the container is removed from above the host or when it is placed under a tap for filling, the sealing of the inlet and outlet is not optimal, resulting in dripping or leakage. Therefore, the container cannot be used as an independent water tank or water container. Moreover, dripping or leakage can dirty the cabinet, floor, or the host at a lower position, as well as the display screen on the host.

In some embodiments, when the host is located below the container, it results in the container being positioned at a higher level (the total height being the sum of the height of the placement surface and the height of the host). Due to the large capacity of the container, it is difficult or requires greater effort for the user to move the container filled with water to the host and align it correctly to connect the pipes or to separate the container from the host. Additionally, due to the high center of gravity of the container, even slight shaking can increase the risk of the container falling.

In other embodiments, when the host is located below the container, the container limits the size of the display screen on the host, making it impossible to set a larger display screen on the host. This affects user interaction with the cooking apparatus or viewing recipe videos and other content displayed on the screen. Furthermore, the inclination angle of the display screen relative to the placement surface is also limited by the size of the host at a lower position, making it difficult to meet the optimal angle for viewing and operation by the user.

In some embodiments, the cooking apparatus may include a container and a stick-type host, which can be attached to the side wall of the container through a clamping mechanism. Part of the stick-type host is inside the container, while another part is outside. In some cases, due to the cumbersome nature of the clamping connection, more time and effort are required when installing or removing the stick-type host from the container. Additionally, during installation or removal, the user's hands may need to be inserted into the container, which can lead to the user's hands getting wet from the liquid inside the container.

In other embodiments, after the stick-type host is clamped onto the side wall of the container, the container's top cover may not be able to fit precisely over the opening of the container. Therefore, a separate top cover needs to be designed for the connection between the stick-type host and the container, or a matching container and top cover must be used, which also reduces the user experience.

In other embodiments, a display screen is also provided at the top of the host. Since the cross-sectional area of the stick-type host in its height direction is limited, it also becomes impossible to install a larger display screen. Due to the weight of a larger display screen, the center of gravity of the cooking apparatus may change, which makes it prone to tilting or toppling. Especially when the host is clamped onto the side wall of the container, the force exerted by the user when touching the screen further increases the likelihood of tilting.

In some other embodiments, when the stick-type host is clamped onto the side wall of the container, part of the stick-type host may extend into the liquid inside the container. Since the stick-type host itself has a certain volume, it affects the volume/height of the liquid level inside the container or occupies part of the container's volume. This may limit the precise control of the liquid temperature in the container or restrict the subsequent addition of other functions, such as an icebox or vacuum bag hanging attachments.

In some other embodiments, a cooking apparatus comprises a host and a container is provided. By improving the placement positions of the host and container, the host is entirely positioned outside the container's accommodating space, allowing the container and host to be arranged side by side. In some cases, this parallel arrangement allows the container to make direct contact with the placement surface, thereby lowering the center of gravity of the container and enhancing the overall stability of the cooking apparatus. Additionally, it is unnecessary to move the container over the host during installation or removal, reducing the difficulty of installation and disassembly. In other In some other embodiments, since the container and the host are placed side by side, it reduces the limitations of size of the display screen on the host by the container, making it easier to set up a larger display screen, thus enhancing user interaction with the display screen. In some embodiments, this specification also improves a connection method between the host and the container, allowing the user to install or remove the host and the container without having to reach into the container, thereby preventing their hands from getting wet. There is no need to design a separate top cover for the container due to the host being clamped onto the side wall of the container. Furthermore, the size of the host is not restricted by the container, allowing for a larger size, which is conducive to setting up a larger display screen. Combined with the parallel placement of the host and the container, this can further meet users' requirements for a large display screen. Finally, when the host and container are connected, the host does not occupy additional volume of the container, making it easier to precisely control the liquid temperature in the container or add other functions subsequently.

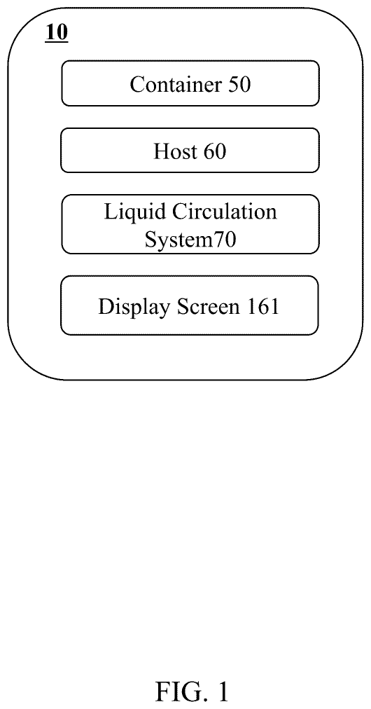

Referring to FIGS. 1 and 4 to 6, in some embodiments, the cooking apparatus 10 may include a host 60 and a container 50. When the cooking apparatus 10 is in normal operation, the host 60 may be set outside the container 50, and the host 60 and the container 50 may be arranged side by side on the placement surface 90.

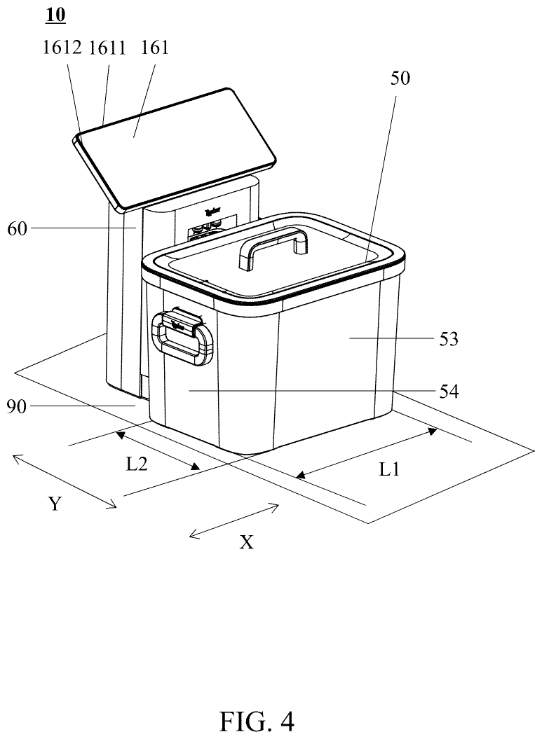

In this embodiment, the host 60 being set outside the container 50 may mean that the host 60 is located outside the accommodating space of the container 50. For instant, the inner surface of the side wall and the bottom wall of the container 50 can enclose and define an accommodating space for containing liquid and ingredients, with the host 60 being completely outside the accommodating space. For instant, in the embodiment shown in FIG. 4, the accommodating space of the container 50 is formed by the inner surface of the side wall, the bottom wall, and the shell 715 of the liquid inlet and outlet component 71, so it can be considered that the host 60 is completely outside the accommodating space. The placement surface 90 may refer to the surface of the structure used to place the container 50 and the host 60, such as the surface of a storage cabinet or a kitchen countertop. The side-by-side arrangement may mean that the container 50 and the host 60 are placed on the placement surface 90 such that one is not above or below the other.

In some embodiments, the side-by-side arrangement may include placing the container 50 and the host 60 along the length direction of the container 50. The length direction of the container 50 may refer to the length direction of the side walls of the container 50, including the length direction of the long sides and the short sides of the container 50. For instant, when the host 60 is set on the shorter side wall (i.e., the short side) of the container 50, it may be considered that the container 50 and the host 60 are arranged along the length direction of the long side of the container 50. In another example, when the host 60 is set on the longer side wall (i.e., the long side) of the container 50, it may be considered that the container 50 and the host 60 are arranged along the length direction of the short side of the container 50.

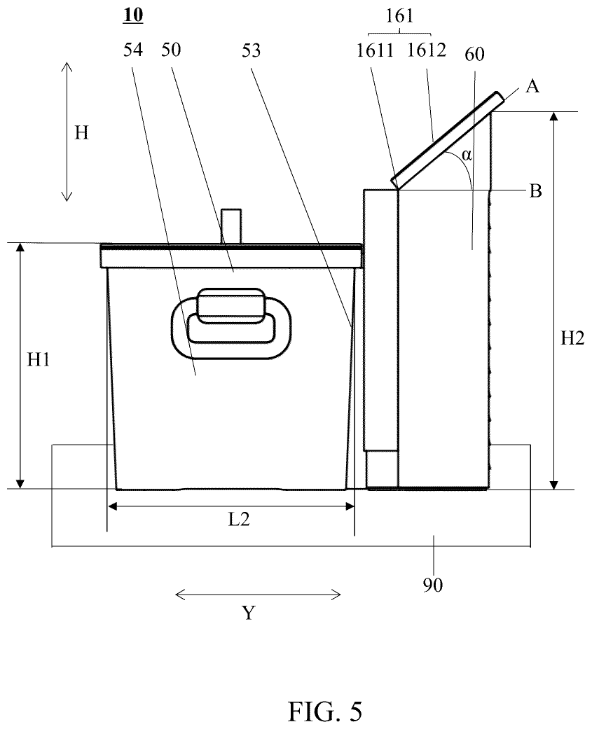

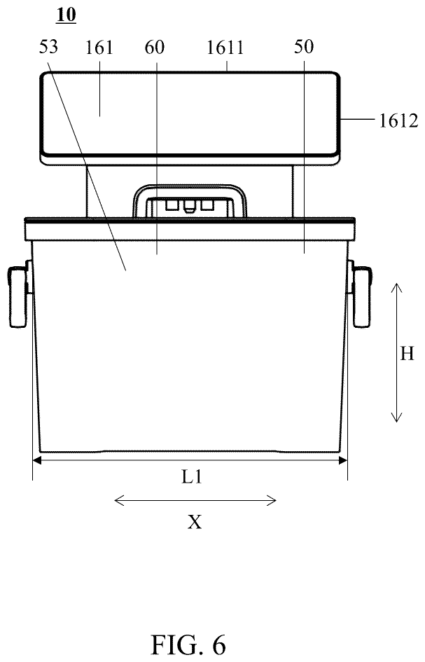

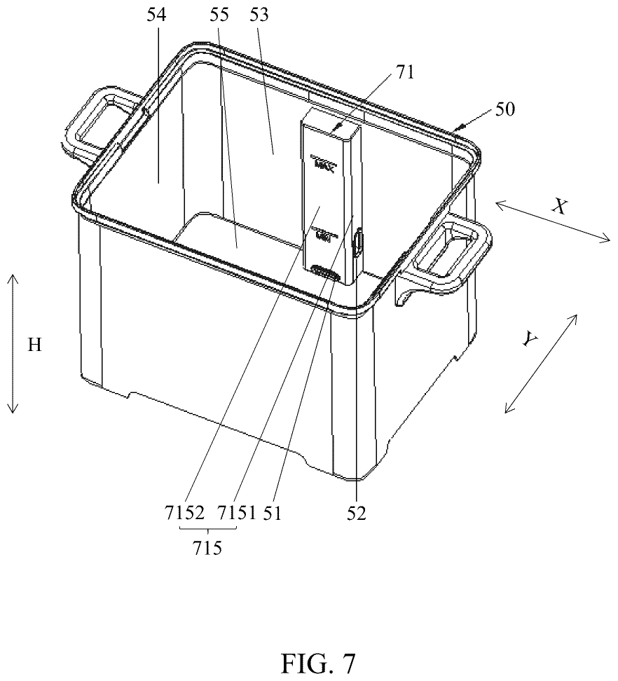

To facilitate understanding of the length direction of the container 50, this specification uses the container 50 shown in FIGS. 4 to 7 and FIG. 11 as an example. In some embodiments, the container 50 may include four interconnected side walls and a bottom wall 55 set on one side of the side walls. The four side walls and the bottom wall 55 together enclose an accommodating space. The four side walls may include two first side walls 53 and two second side walls 54. The length of the first side wall 53 is greater than the length of the second side wall 54. Thus, the first side wall 53 forms the long side of the container 50, and the second side wall 54 forms the short side (which may also be referred to as the width side) of the container 50. The length direction of the first side wall 53 can be indicated by arrow X in FIGS. 4 and 6. The length direction of the second side wall 54 can be indicated by arrow Y in FIGS. 5 and 4. The connection between the first side wall 53 and the second side wall 54 may be an arc, giving the internal contour of the container 50 a cuboid-like shape. As shown in FIG. 5, when the host 60 is set on the first side wall 53 of the container 50, it may be considered that the container 50 and the host 60 are arranged along the length direction of the short side of the container 50. Thus, the length direction of the short side of the container 50 is the arrangement direction of the container 50 and the host 60, as indicated by arrow Y in FIGS. 5 and 4. The arrangement direction here refers to the direction in which the container 50 and the host 60 are placed. The height direction of the container 50 may refer to the height direction of the first side wall 53 and the second side wall 54, as indicated by arrow H in FIGS. 6 and 7. The height direction of the container 50 is perpendicular to both the length direction and the width direction.

In some embodiment, after the host 60 and the container 50 are arranged side by side on the placement surface 90, the bottom of the container 50 may directly contact the placement surface 90, effectively lowering the height of the center of gravity of container 50, thereby reducing the likelihood of the container 50 tilting. At the same time, since the container 50 does not limit the size of the display screen 161, a larger display screen 161 can be set on the host 60. This facilitates user interaction with the cooking apparatus 10 or viewing recipe videos and other content on the display screen 161. Moreover, the inclination angle of the display screen 161 relative to the placement surface 90 is not limited by the size of the host 60, effectively meeting the optimal viewing and operating angle for the user.

In other embodiment, since the host 60 and the container 50 are arranged side by side, there is no need to provide an inlet and outlet at the bottom of the container 50. Instead, the liquid exchange between the host 60 and the container 50 is achieved through the liquid inlet and outlet components and the host pipe assembles provided by some embodiments of this specification. Even when the host 60 and the container 50 are separated, the container 50 can still be used as an independent water tank or container for holding liquid.

In some embodiments, the host 60 can be connected to the longer side wall of the container 50. For instant, in the embodiment shown in FIGS. 4 to 6, the first side wall 53 of the container 50 is the longer side wall, i.e., the long side of the container 50. The host 60 can be set on the first side wall 53. In other embodiments, the host 60 can be set on the shorter side wall of the container 50. For instant, the host 60 can be set on the second side wall 54 of the container 50.

In some embodiments, the height of the host 60 may be greater than the height of the container 50. The height of the container 50 may refer to the dimension from the top to the bottom of the container 50, which can be represented by H1 in FIG. 5. The height of the host 60 may refer to the dimension of the host 60 in the height direction of the container 50, represented by H2 in FIG. 5.

In some embodiments, the shape of the container 50 may include a cylindrical shape (e.g., a cylinder), a prismatic shape (e.g., a rectangular prism, cube, etc.), a conical shape (e.g., cone, pyramid), or any other feasible shape. The shape here refers to the external contour of the container 50. FIG. 5 exemplarily shows a structure of a container 50, where the external contour of the container 50 is roughly cuboid (i.e., based on a rectangular prism, the connecting surface between the first side wall 53 and the second side wall 54 is replaced with an arc), with the host 60 set on the first side wall 53 of the container 50. It should be noted that FIG. 5 is for illustrative purposes only and does not limit the shape of the container 50 or the positional relationship between the container 50 and the host 60. For instant, the external contour of the container 50 may be cylindrical, such as a barrel structure. In this embodiment, when the host 60 is entirely located outside the accommodating space of the barrel structure, the host 60 and the barrel structure can be considered arranged side by side.

In some embodiments, the container 50 may have a double-layer structure. The container 50 may include an inner layer and an outer layer, with the outer layer and the inner layer connected to each other, and an air gap between the outer layer and the inner layer to reduce heat loss from the container 50. In some embodiments, the length of the outer layer of the container 50, denoted as L1, may be 343.86 mm. In some embodiments, the width of the outer layer of the container 50, denoted as L2, may be 255.89 mm. In some embodiments, the height of the outer layer of the container 50 may be in the range of 241.89 mm.

In some embodiments, the difference between the dimensions of the outer layer and the inner layer of the container 50 may be greater than or equal to 5 mm. For instant, the length, width, and height of the inner layer of the container 50 may be 5 mm smaller than the dimensions of the outer layer.

In some embodiments, the dimensions of the container 10 may be determined based on the size of the vacuum bags. In some embodiments, two types of vacuum bags are used: a large vacuum bag that can be placed along the long side of the container 10, and a small vacuum bag that can be placed along the short side of the container 10, 4 small vacuum bags can be placed along the short side of the container 10. The dimensions of the large vacuum bag may be 300 mm×215 mm (long side length x short side length). The dimensions of the small vacuum bag may be 210 mm×215 mm.

In some embodiments, the ratio of the area of the small vacuum bag to the area of the first side wall 102 may be in the range of 0.7 to 1. In some embodiments, the ratio of the area of the small vacuum bag to the area of the first side wall 102 may be in the range of 0.7 to 0.8. In some embodiments, the ratio of the area of the small vacuum bag to the area of the first side wall 102 may be 0.73. In some embodiments, the ratio of the area of the large vacuum bag to the area of the second side wall 103 may be in the range of 0.7 to 1. In some embodiments, the ratio of the area of the large vacuum bag to the area of the second side wall 103 may be in the range of 0.7 to 0.8. In some embodiments, the ratio of the area of the large vacuum bag to the area of the second side wall 103 may be 0.77. If the size difference between the vacuum bags and the container 50 is too small, it will result in a smaller gap between the vacuum bags and the inner wall of the container 50, which hinders the flow of liquid around the vacuum bags, leading to uneven liquid temperatures around the bags and uneven heating of the food inside. If the ratio is too small, it results in wasted space. In some embodiments, the volume of the container 10 may be greater than or equal to 12 L.

In some embodiments, the size of the host 60 in the length direction of the long side of the container 50 (i.e., the length direction of the first side wall 53) may be in the range of 100 mm to 300 mm. In some embodiments, the size of the host 60 in the length direction of the first side wall 53 of the container 50 may be in the range of 200 mm to 250 mm. In some embodiments, the size of the host 60 in the length direction of the first side wall 53 of the container 50 may be 223.48 mm.

In some embodiments, the ratio of the size of the host 60 in the length direction of the first side wall 53 of the container 50 to the length L1 of the first side wall 53 may be in the range of 0.3 to 0.8. In some embodiments, the ratio of the size of the host 60 in the length direction of the first side wall 53 to the length L1 of the first side wall 53 may be in the range of 0.4 to 0.7. In some embodiments, the ratio of the size of the host 60 in the length direction of the first side wall 53 to the length L1 of the first side wall 53 may be in the range of 0.6 to 0.65.

As shown in FIG. 5, in some embodiments, both the bottom surface of the host 60 and the bottom surface of the container 50 may be in contact with the placement surface 90. In some cases, the liquid inside the container 50 may experience oscillation, causing the container 50 to shake. The amplitude of such shaking increases with the volume of liquid inside the container 50. In some embodiments, compared to the arrangement where the host 60 is set below the container 50, the center of gravity of the container 50 is not affected by the height of the host 60. Additionally, when both the container 50 and the host 60 are in contact with the placement surface 90, they can simultaneously provide support, improving the stability of the container 50 and the host 60 and reducing the likelihood of tilting.

As shown in FIGS. 1 and 4 to 6, in some embodiments, the cooking apparatus 10 may also include a display screen 161, which may be set on the host 60. In some embodiments, the display screen 161 may be set at the highest position of the host 60. As shown in FIG. 5, one end of the host 60 is in contact with the placement surface 90, while the back of the display screen 161 is connected to the end of the host 60 that is away from the placement surface 90, making the display screen 161 at the highest position of the host 60. In some embodiments, increasing the height of the display screen 161 can prevent the display screen 161 from colliding with the container 50 during the connection of the host 60 and the container 50. It can also prevent splashes from the container 50 from reaching the display screen 161, which may affect user operation.

Referring to FIGS. 5 to 6, in some embodiments, the display screen 161 may form an angle relative to the placement surface 90 to facilitate user viewing and/or operation of the display screen 161. The plane of the display screen 161 can be represented by A in FIG. 5, and the placement surface 90 can be parallel to plane B in FIG. 5. The angle between plane A and plane B can be represented by α in FIG. 5. In some embodiments, the value range of the angle α between the plane of the display screen 161 and the placement surface 90 may be 15 to 75 degrees. In some embodiments, the value range of the angle α may be 25 to 65 degrees. In some embodiments, the value range of the angle α may be 30 to 60 degrees.

In some embodiments, the angle α between the plane of the display screen 161 and the placement surface 90 can be adjusted. For instant, the display screen 161 may be rotatably connected to the end surface of the host 60. This connection can be achieved through hinge connections, pin connections, gear connections, etc., allowing the display screen 161 to rotate relative to the end surface of the host 60.

In some embodiments, the user can manually adjust the angle between the plane of the display screen 161 and the placement surface 90, For instant, by directly holding the display screen 161 and rotating it relative to the end surface of the host 60. In other embodiments, the cooking apparatus 10 can automatically adjust the angle between the plane of the display screen 161 and the placement surface 90. For instant, the cooking apparatus 10 may include an angle adjustment component, which may comprise a position detection device and a mechanical control component. The position detection component can be used to detect the user's position, and the mechanical control component can adjust the angle between the plane of the display screen 161 and the placement surface 90 based on the user's position. In some embodiments, the position detection device may include a visual sensor (e.g., camera), distance sensor (e.g., optical distance sensor, infrared distance sensor, ultrasonic distance sensor), etc.

In some embodiments, the lowest point of the display screen 161 may be higher than the highest point of the container 50. As shown in FIG. 5, the third side wall 1611 on the left side of the display screen 161 is at the lowest position of the display screen 161, and the third side wall 1611 is higher than the highest point of the container 50. Therefore, the entire display screen 161 is located above the container 50.

In some embodiments, because the display screen 161 is entirely higher than the container 50, it is difficult for the liquid in the container 50 to splash onto the display screen 161. Additionally, the fact that the display screen 161 is entirely higher than the container 50 makes it easier to set up a larger display screen 161, which can enhance interactivity and make it more convenient for users to view content such as recipe videos. In other embodiments, it can also prevent the display screen 161 from being obscured by the container 50 and prevent the container 50 from colliding with the display screen 161 during the connection of the container 50 and the host 60.

In some embodiments, in the height direction of the container 50, the side wall of the container 50 near the display screen 161 does not overlap with the side wall of the display screen 161 near the container 50. FIG. 5 exemplarily shows a side view of the cooking apparatus 10. As shown in FIG. 5, when the liquid inlet and outlet component 71 is connected with the host pipe assembly 72, the third side wall 1611 of the display screen 161 near the container 50 is spaced a certain distance from the first side wall 53 of the container 50 near the display screen 161. Thus, the side wall of the container 50 near the display screen 161 does not overlap with the side wall of the display screen 161 near the container 50, creating a clearance area between them. In some embodiments, the clearance area can effectively prevent the container 50 from colliding with the display screen 161 during the docking process between the container 50 and the host 60.

In some embodiments, the length of the long side of the display screen 161 may be less than the length of the long side of the container 50. The length of the long side of the display screen 161 refers to the length of the third side wall 1611. In some embodiments, the length of the short side of the display screen 161 may be less than the length of the short side of the container 50. The length of the short side of the display screen 161 refers to the length of the fourth side wall 1612.

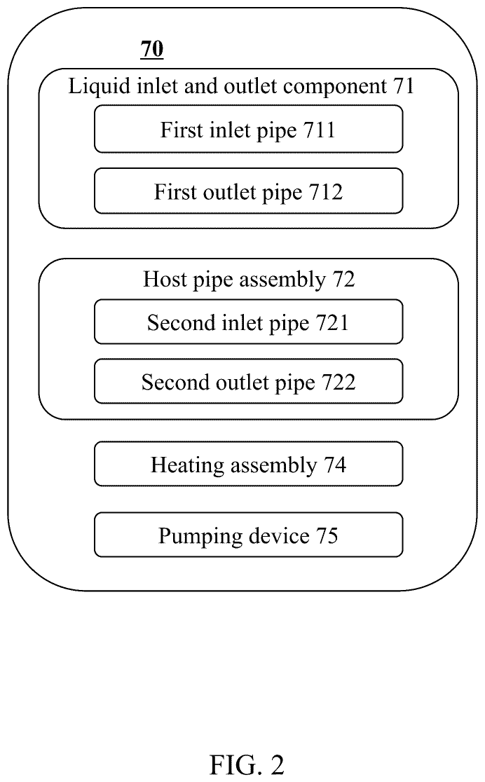

Referring to FIGS. 1 and 2, in some embodiments, the cooking apparatus 10 may include a liquid circulation system 70, which can be used to allow liquid to flow between the host 60 and the container 50. In some embodiments, the host 60 may include a host pipe assembly 72, and the container 50 may include a liquid inlet and outlet component 71. When the liquid inlet and outlet component 71 is connected to the host pipe assembly 72, it allows the liquid to flow between the host 60 and the container 50. The liquid in the container 50 can be discharged through the liquid inlet and outlet component 71 and enter the pipes on the side of the host 60 (e.g., the host pipe assembly 72). Then it can flow back into the container 50 through the host pipe assembly 72 and the liquid inlet and outlet component 71, thus forming a liquid circulation between the host 60 and the container 50.

In some embodiments, the liquid inlet and outlet component 71 and the host pipe assembly 72 may be detachably connected. In other embodiments, the liquid inlet and outlet component 71 and the host pipe assembly 72 may be fixedly connected.

In some embodiments, the liquid circulation system 70 may also include a pumping device 75. The pumping device 75 can be used to pump liquid into the host pipe assembly 72 and the liquid inlet and outlet component 71, to deliver the liquid from the host 60 to the container 50, or to deliver the liquid from the container 50 to the host 60.

In some embodiments, the specific fitting method between the pumping device 75 and the liquid inlet and outlet component 71 or the host pipe assembly 72 is related to the type of pumping device 75. In some embodiments, the type of pumping device 75 may include a reciprocating pump, plunger pump, piston pump, diaphragm pump, rotary pump, peristaltic pump, and so on. For clarity, a peristaltic pump is used as an example for explanation. The peristaltic pump can be arranged outside the first inlet pipe 711, the second inlet pipe 721, the first outlet pipe 712, and the second outlet pipe 722, and pumps the liquid in the inlet pipe 210 and the outlet pipe 220 by squeezing them. In another embodiments, the pumping device 75 may also be a hydraulic pump, which can be directly connected to the inlet pipe (e.g., the first inlet pipe 711 and the second inlet pipe 721) and the outlet pipe (e.g., the first outlet pipe 712 and the second outlet pipe 722) to pump liquid by changing the pressure in the pipeline.

In some embodiments, the host 60 may include a vacuum pump. The vacuum pump is arranged on the pipes of the liquid circulation system 70. After the liquid circulation system 70 finishes the circulation heating or cooling process, the pumping device 75 stops working, and the liquid stops circulating. At this time, the vacuum pump can be started, and when the vacuum pump is in operation, it can discharge the residual liquid in the pipes of the liquid circulation system 70 back to the container 50 through its self-priming function. The self-priming function of the vacuum pump refers to: when the vacuum pump is working, it can evacuate air to create negative pressure in the pipes related to liquid circulation, and the residual liquid in the pipes of the liquid circulation system 70 is discharged under the action of negative pressure.

In some embodiments, after the vacuum pump discharges the residual liquid in the pipes of the liquid circulation system 70, an air section is formed in the pipes of the liquid circulation system 70. When an air section is formed in the pipes of the liquid circulation system 70, there will also be an air section inside the pumping device 75, causing the pumping device 75 to be not fully filled with liquid, which will prevent the pumping device 75 from drawing liquid or make it draw liquid slowly, thus affecting the normal operation of the cooking apparatus 10. In some embodiments, the vacuum pump can be started before the pumping device 75 of the cooking apparatus 10 starts working. By using the self-priming function of the vacuum pump, negative pressure is created after forming a vacuum in the pipes of the liquid circulation system 70, thereby generating suction to draw the air from the pipes of the liquid circulation system 70 so that the liquid in the container 10 can fully or partially fill the pumping device 75, enabling the pumping device 75 or cooking apparatus 10 to operate normally.

By providing a vacuum pump in the cooking apparatus 10, on the one hand, after the liquid circulation heating or cooling process of the cooking apparatus 10 ends, the residual liquid in the pipes of the liquid circulation system 70 can be discharged to the container 50 using the self-priming function of the vacuum pump, thereby ensuring no residual liquid remains in the pipes of the liquid circulation system 70. On the other hand, before the start of the liquid circulation heating or cooling process of the cooking apparatus 10 (i.e., before the pumping device 75 starts), suction is generated using the self-priming function of the vacuum pump to remove air from the pipes of the liquid circulation system 70, allowing the liquid from the container 50 to flow into the pipes of the liquid circulation system 70 and into the pumping device 75, thus ensuring the normal operation of the pumping device 75.

In some embodiments, the host 60 may also include a heating assembly 74, which can be used to heat the liquid delivered to the pipes of the host 60 (e.g., the pipes of the host pipe assembly 72), thereby controlling the liquid temperature in the container 50. In some embodiments, the heating assembly 74 may include a heating element arranged in the host 60, which may include a heating tube, heating strip, etc. For instant, a heating tube with a certain temperature can be arranged outside the pipes of the host pipe assembly 72 to heat the liquid delivered to the host pipe assembly 72.

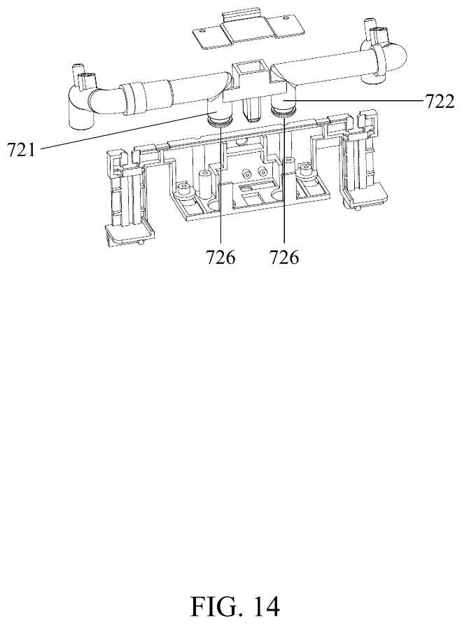

Referring to FIGS. 1 to 2 and FIGS. 7 to 14, in some embodiments, the liquid inlet and outlet component 71 may include a first inlet pipe 711 and a first outlet pipe 712. The first inlet pipe 711 may communicate with the inlet port 51 of the container 50, and the first outlet pipe 712 may communicate with the outlet port 52 of the container 50. The host pipe assembly 72 may include a second inlet pipe 721 and a second outlet pipe 722. The second inlet pipe 721 may communicate with the first inlet pipe 711, and the second outlet pipe 722 may communicate with the first outlet pipe 712. The second inlet pipe 721 also may communicate with the second outlet pipe 722. Here, the inlet port 51 refers to an opening through which liquid enters the container 50 from outside, and the outlet port 52 refers to an opening through which liquid is discharged from the container 50. In this embodiment, the liquid in the container 50 can enter the first outlet pipe 712 through the outlet port 52, then be delivered to the second outlet pipe 722. After being heated by the heating assembly 74, it flows into the second inlet pipe 721 and returns to the container 50 through the first inlet pipe 711 and the inlet port 51.

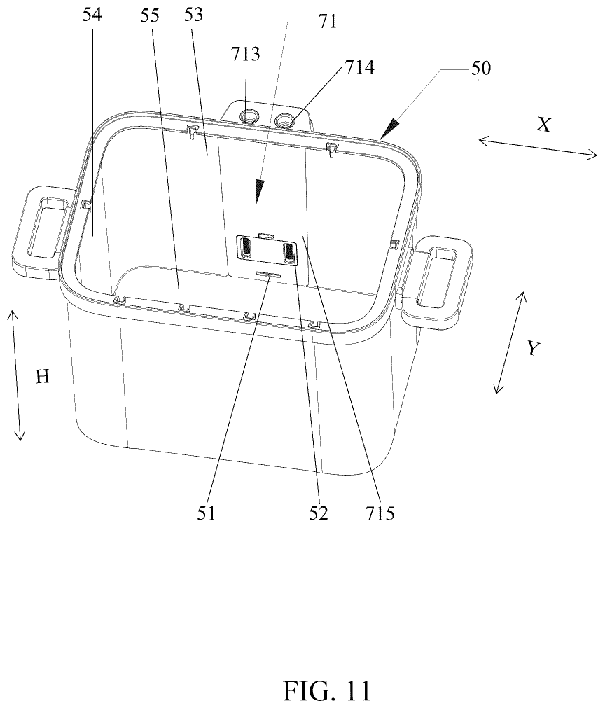

The docking port where the first inlet pipe 711 and the second inlet pipe 721 are connected can be called the first docking port 713. The docking port where the first outlet pipe 712 and the second outlet pipe 722 are connected can be called the second docking port 714. FIG. 11 shows the structure of the first docking port 713 and the second docking port 714. In the embodiment shown in FIG. 11, the first docking port 713 and the second docking port 714 of the liquid inlet and outlet component 71 are not connected to the host pipe assembly 72.

In some embodiments, the inlet port 51 and the outlet port 52 are not directly provided on the container 50 but are arranged on the liquid inlet and outlet component 71. In the embodiment shown in FIG. 11, the inlet port 51 and the outlet port 52 are both arranged on the housing 715 of the liquid inlet and outlet component 71. The internal pipes of the container 50 are connected to the pipes of the host 60 through the inlet and outlet pipes to deliver liquid. In some embodiments, the inlet port 51 and the outlet port 52 may be located on the same side wall of the container 50. In the embodiment shown in FIG. 11, the inlet port 51 and the outlet port 52 are both arranged on the housing 715 of the liquid inlet and outlet component 71. The housing 715 is arranged on the first side wall 53 of the container 50, and the housing 715 is flush with the inner surface of the first side wall 53, so the inlet port 51 and the outlet port 52 can be located on the first side wall 53. In another embodiments, the inlet port 51 and the outlet port 52 may both be arranged on the second side wall 54 of the container 50.

In some cases, the liquid injected from the inlet port 51 may collide with the side wall opposite the inlet port 51 and then form several liquid streams flowing in different directions (e.g., upper left, upper right, etc.). Because the inlet port 51 and the outlet port 52 are located on the same side wall, under the suction of the outlet port 52, the several streams will return along different paths to the side wall where the inlet port 51 is located and eventually converge at the outlet port 52. During the process of several streams returning to the outlet port 52, the streams can stir the liquid in different areas, causing more liquid to mix and further improving the uniformity of the liquid temperature inside the container 50.

In some embodiments, the inlet port 51 and the outlet port 52 may be arranged on different side walls of the container 50. In some embodiments, the inlet port 51 and the outlet port 52 may be arranged on two opposite side walls. For instant, the inlet port 51 and the outlet port 52 can be arranged on two opposite first side walls 53 or second side walls 54, respectively. In some embodiments, the inlet port 51 and the outlet port 52 may be arranged at both ends of the diagonal of the inner wall of the container 50.

In some embodiments, the inlet port 51 and the outlet port 52 are arranged on the same side wall, and the host 60 may be arranged on the side wall where the inlet port 51 and the outlet port 52 are located. In some embodiments, liquid needs to enter the container 50 through the inlet port 51 and be discharged from the container 50 through the outlet port 52. The liquid discharged from the container 50 is delivered to the side of the host 60 through the pipes of the liquid circulation system 70, and then flows back to the container 50 through the pipes of the liquid circulation system 70. Therefore, when the inlet port 51, outlet port 52, and the host 60 are all arranged on the same side wall, the length of the pipes in the liquid circulation system 70 can be shortened, which is conducive to reducing the overall size of the cooking apparatus 10. As shown in FIGS. 4 to 6 and FIG. 11, in some embodiments, both the inlet port 51 and the outlet port 52 are arranged on the housing 715 of the liquid inlet and outlet component 71, so the inlet port 51 and the outlet port 52 can be considered to be located on the first side wall 53. The host 60 can be arranged on the first side wall 53 as well.

In some embodiments, at least part of the first inlet pipe 711 is located above the highest water level of the container 50 and close to the first docking port 713. At least part of the second inlet pipe 721 is located above the highest water level of the container 50 and close to the second docking port 714. In some embodiments, the liquid pressure at the inlet port 51 can be reduced. Reducing the liquid pressure can facilitate the entry of liquid into the container 50 from the inlet port 51, resulting in better agitation of the liquid. In some embodiments, it can prevent the liquid in the container 50 from entering the pipes of the host, causing the pipes to smell bad. In other embodiments, it can prevent the liquid in the container 50 from flowing out of the second docking port 714 when the second docking port 714 is disconnected from other structures (e.g., the pumping device 75).

This specification also provides another cooking apparatus 10. Referring to FIGS. 1, 4 to 6, in some embodiments, the cooking apparatus 10 may include the host 60 and the container 50. The host 60 is arranged outside the container 50, and the bottom surface of the host 60 and the bottom surface of the container 50 both contact the placement surface 90.

In some embodiments, the cooking apparatus 10 may also include a display screen 161, which can be arranged on the host 60. More details regarding the container 50, the host 60, and the display screen 161 can be found in other embodiments in the specification and are not repeated here.

In some embodiments, the host 60 may be arranged on the longer side wall of the container 50.

In some embodiments, the inlet port 51 and the outlet port 52 are arranged on the same side wall, and the host 60 may be arranged on the side wall where the inlet port 51 and the outlet port 52 are located.

In some embodiments, the host 60 may include a host pipe assembly 72, and the container 50 may include a liquid inlet and outlet component 71. When the liquid inlet and outlet component 71 is connected to the host pipe assembly 72, a passage for liquid to flow between the host 60 and the container 50 can be formed. The liquid circulation system in this embodiment can be the same as or similar to the liquid circulation system 70 in other embodiments of this specification, and is not repeated here.

In some embodiments, the liquid inlet and outlet component 71 may include a first inlet pipe 711 and a first outlet pipe 712. The first inlet pipe 711 can communicate with the inlet port 51 of the container 50, and the first outlet pipe 712 can communicate with the outlet port 52 of the container 50. The host pipe assembly 72 may include a second inlet pipe 721 and a second outlet pipe 722. The second inlet pipe 721 can communicate with the first inlet pipe 711, and the second outlet pipe 722 can communicate with the first outlet pipe 712. The second inlet pipe 721 also communicates with the second outlet pipe 722. Here, the inlet port 51 refers to an opening through which liquid enters the container 50 from outside, and the outlet port 52 refers to an opening through which liquid is discharged from the container 50. In this embodiment, the liquid in the container 50 can enter the first outlet pipe 712 through the outlet port 52, then be delivered to the second outlet pipe 722. After being heated by the heating assembly 74, it flows into the second inlet pipe 721 and returns to the container 50 through the first inlet pipe 711 and the inlet port 51.

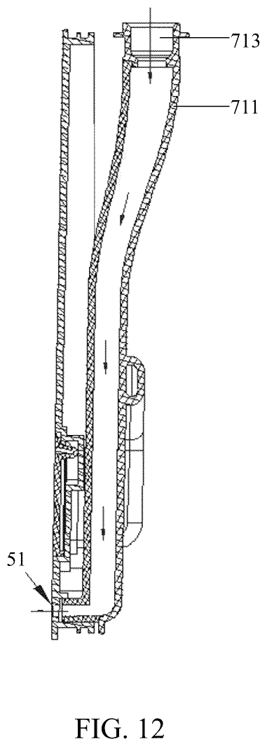

This specification also provides another liquid inlet and outlet component 71. As shown in FIGS. 11 to 12, in some embodiments, the liquid inlet and outlet component 71 may include a housing 715. The housing 715 may be in a plate-like structure, with the surface of the plate-like structure of the housing 715 flush with the inner surface of the first side wall 53. The outlet port 52 and the inlet port 51 are arranged on the housing 715. As shown in FIG. 12, in some embodiments, the first outlet pipe 712 and the first inlet pipe 711 of the liquid inlet and outlet component 71 may be arranged on the side of the housing 715 away from the interior of the container 50, and are respectively connected to the inlet port 51 and the outlet port 52.

Referring to FIGS. 11 and 12, in some embodiments, the liquid inlet and outlet component 71 may include the first docking port 713, the second docking port 714, the first outlet pipe 712, and the first inlet pipe 711. The first outlet pipe 712 can communicate with both the second docking port 714 and the outlet port 52. The first inlet pipe 711 can communicate with both the first docking port 713 and the inlet port 51. The first docking port 713 and the second docking port 714 can be used to connect with the second inlet pipe 721 and the second outlet pipe 722 of the host pipe assembly 72.

It should be noted that although the specific structures of the first docking port 713, the second docking port 714, the first inlet pipe 711, and the first outlet pipe 712 are not shown in FIG. 7, the liquid inlet and outlet component 71 in FIG. 7 still has relevant structures such as the first docking port 713, the second docking port 714, the first inlet pipe 711, and the first outlet pipe 712.

In some embodiments, the housing 715 can be a part of the side wall of the container 50. For instant, in the embodiment shown in FIG. 11, the housing 715 can be part of the first side wall 53, and other components of the liquid inlet and outlet component 71 can be connected to the housing 715, thus connecting to the container 50. In some embodiments, the housing 715 can be integrally formed with the side wall of the container 50. In other embodiments, the housing 715 can be independent of the side wall of the container 50. For instant, in the embodiment shown in FIG. 7, the first side wall 53 of the container 50 can have a notch that is adapted to the housing 715, and the housing 715 can be embedded in this notch. In some embodiments, the housing 715 can be fixedly connected to the side wall of the container 50.

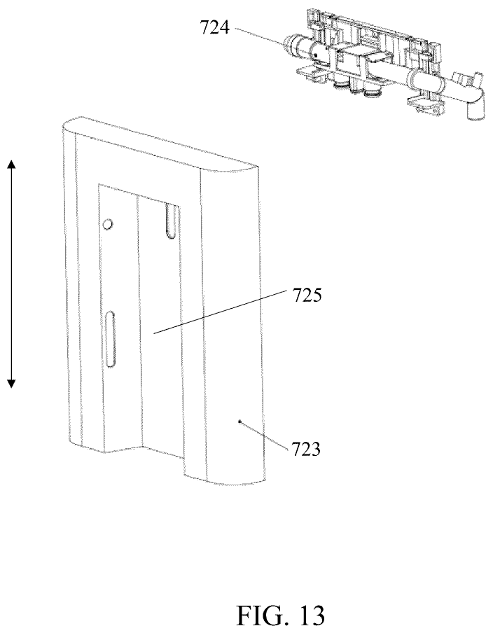

As shown in FIGS. 11 to 14, in some embodiments, the liquid inlet and outlet component 71 may include a protruding structure disposed on the outside of the first side wall 53 of the container 50, and the top end of the protruding structure is provided with the first docking port 713 and the docking port 714. The host pipe assembly 72 may include a front shell 723 disposed on the host 60 and a host pipe connection structure 724 disposed inside the top end of the front shell 723. The front shell 723 may move in the vertical direction, and one side of the front shell 723 is provided with a mounting slot 725. The host pipe connection structure 724 may include a second inlet pipe 721 and a second outlet pipe 722. When connecting the host 60 and the container 50, the protruding structure can be accommodated in the mounting slot 725, and by moving the front shell 723 in the vertical direction (as indicated by the arrow in FIG. 13), the second inlet pipe 721 and the second outlet pipe 722 in the front shell 723 can be inserted into the first docking port 713 and the second docking port 714, respectively, to mate with the first inlet pipe 711 and the first outlet pipe 712.

In some embodiments, the second inlet pipe 721 and the second outlet pipe 722 are provided with seals 726, which are used for the tight fit when the second inlet pipe 721 and the second outlet pipe 722 are inserted into the first docking port 713 and the second docking port 714, and to enhance the sealing. Seals may be silicone rings.

This specification provides a liquid inlet and outlet component 71, and FIG. 7 illustratively shows a schematic diagram of the structure of the liquid inlet and outlet component 71 when connected to the container 50. As shown in FIG. 7, the liquid inlet and outlet component 71 may include a housing 715, and a receiving space may be formed inside the housing 715 to accommodate other components of the liquid inlet and outlet component 71, such as the first inlet pipe 711 and the second inlet pipe 721. In some embodiments, the housing 715 is disposed on the first side wall 53 of the container 50 and protrudes towards the inside of the container 50. In some embodiments, the housing 715 may include a first housing side wall 7151 and a second housing side wall 7152. The two sides of the first housing side wall 7151 are respectively connected to the second housing side wall 7152 and the first side wall 53 of the container 50. The second housing side wall 7152 is located on the side of the first housing side wall 7151 that is away from the first side wall 53. The first housing side wall 7151 is provided with an outlet 52, and the second housing side wall 7152 is provided with an inlet 51.

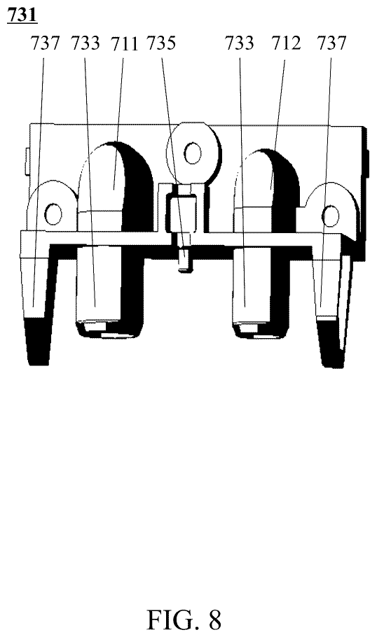

This specification also provides another assembly for realizing liquid circulation. As shown in FIGS. 8 to 10, in some embodiments, the liquid inlet and outlet component 71 may include a container connector 731, which may be provided with the first inlet pipe 711 and the first outlet pipe 712. The host pipe assembly 72 may include a host connector 732, which may be provided with the second inlet pipe 721 and the second outlet pipe 722. When the host connector 732 and the container connector 731 mate with each other, the first inlet pipe 711 and the second inlet pipe 721 are connected, and the first outlet pipe 712 and the second outlet pipe 722 are connected.

The container connector 731 and the host connector 732 can refer to connector structures used to seal and connect two components. When the container connector 731 and the host connector 732 mate, there is a sealed connection between the first inlet pipe 711 and the second inlet pipe 721, as well as between the first outlet pipe 712 and the second outlet pipe 722.

The first inlet pipe 711 and the second inlet pipe 721 can be used to deliver the liquid on the side of the host 60 to the inside of the container 50. It should be noted that the side of the host 60 in one or more embodiments of this specification can refer to the pipeline in the main pipeline assembly 72 provided on the host 60. The first inlet pipe 711 can be connected to the inlet 51 of the container 50. One end of the second inlet pipe 721 can be connected to the second outlet pipe 722, and the other end can be directly connected to the first inlet pipe 711. After the first inlet pipe 711 and the second inlet pipe 721 are mated, the liquid in the pipe on the side of the host 60 can sequentially enter the inside of the container 50 via the second inlet pipe 721, the first inlet pipe 711, and the inlet 51. The first outlet pipe 712 and the second outlet pipe 722 can be used to deliver the liquid inside the container 50 to the host 60. In some embodiments, the first outlet pipe 712 can be connected to the outlet 52 of the container 50. One end of the second outlet pipe 722 can be connected to the first outlet pipe 712, and the other end can be directly connected to the second inlet pipe 721. After the first outlet pipe 712 and the second outlet pipe 722 are mated, the liquid inside the container 50 can sequentially enter the side of the host 60 via the outlet 52, the first outlet pipe 712, and the second outlet pipe 722.

In some embodiments, in addition to the connector structure, the mating structure may also include detachable structures such as latch structures, flip structures, and snap structures.

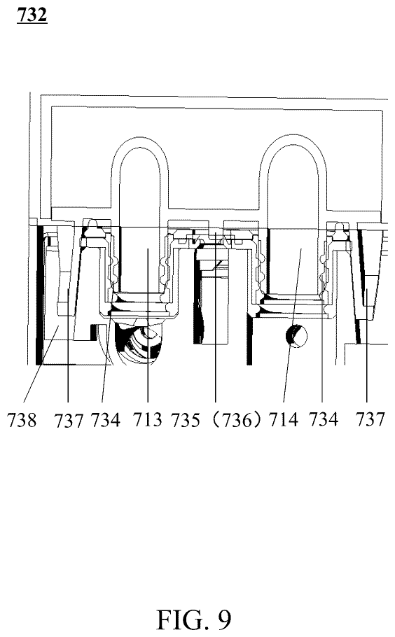

As shown in FIGS. 8 and 9, in some embodiments, the container connector 731 may also be provided with a guide post 737. The host connector 732 may also be provided with a guide groove 738 that fits the guide post 737. The guide post 737 may be located on the outside of a first positioning post 733 of the container connector 731. The guide groove 738 may be located on the outside of a first positioning hole 734. The guide post 737 and the guide groove 738 can be used to guide the mating between the first positioning post 733 and the first positioning hole 734. The outside of the first positioning post 733 may refer to the side of the first positioning post 733 that is away from the first inlet pipe 711 or the first outlet pipe 712, For instant, the guide post 737 in FIG. 9 is located on the outside of the first positioning post 733. The outside of the first positioning hole 734 may refer to the side of the first positioning hole 734 that is away from the second inlet pipe 721 or the second outlet pipe 722, For instant, the guide groove 738 in FIG. 9 is located on the outside of the first positioning hole 734.

As shown in FIGS. 8 and 9, in some specific embodiments, two guide posts 737 are provided on the container connector 731, with the two guide posts 737 respectively located on the outside of the first positioning post 733. Two guide grooves 738 are provided on the host connector 732, with the two guide grooves 738 respectively located on the outside of the first positioning hole 734. Before mating the host connector 732 and the container connector 731, the guide posts 737 can be matched with the corresponding guide grooves 738. When the guide posts 737 slide within the guide grooves 738, the guide grooves 738 can limit the wobbling of the guide posts 737, thereby limiting the relative wobbling of the container connector 731 and the host connector 732. By restricting the relative movement direction of the host connector 732 and the container connector 731, the mating of the first positioning post 733 and the first positioning hole 734 is guided.

In some embodiments, the guide posts 737 can have a draft angle to facilitate the removal of the guide posts 737 from the die-casting mold after casting.

As shown in FIGS. 8 and 9, in some embodiments, there may be two first positioning posts 733 and two first positioning holes 734. The two first positioning posts 733 are respectively provided on the outside of the first inlet pipe 711 and the first outlet pipe 712. The two first positioning holes 734 are respectively provided on the outside of the second inlet pipe 721 and the second outlet pipe 722 to correspond to the positions of the first positioning posts 733.

The outside of the first inlet pipe 711 and the first outlet pipe 712 refers to the side of either the first inlet pipe 711 or the first outlet pipe 712 that is away from the other, such as the position of the first positioning post 733 in FIG. 8. Similarly, the outside of the second inlet pipe 721 and the second outlet pipe 722 refers to the side of either the second inlet pipe 721 or the second outlet pipe 722 that is away from the other, such as the position of the first positioning hole 734 in FIG. 9.

As shown in FIGS. 8 to 9, in some embodiments, the positioning structure may further include a second positioning post 735 and a second positioning hole 736 that is adapted to the second positioning post 735. The second positioning post 735 can be provided on the container connector 731 and located between the first inlet pipe 711 and the first outlet pipe 712. The length of the first positioning post 733 can be greater than that of the second positioning post 735. The second positioning hole 736 can be provided on the host connector 732 and located between the second inlet pipe 721 and the second outlet pipe 722. When the distance that the second positioning post 735 extends into the second positioning hole 736 reaches a second preset distance, the container connector 731 and the host connector 732 are mated. In this embodiment, since the length of the first positioning post 733 is greater than that of the second positioning post 735, when the first positioning post 733 initially mates with the first positioning hole 734, the second positioning post 735 has not yet mated with the second positioning hole 736. The process of mating the first positioning post 733 and the first positioning hole 734 serves as the first alignment of the container connector 731 and the host connector 732. As the container connector 731 and the host connector 732 continue to move relative to each other, when the distance that the first positioning post 733 extends into the first positioning hole 734 reaches a first preset distance, the second positioning post 735 can mate with the second positioning hole 736. The process of mating the second positioning post 735 with the second positioning hole 736 serves as the second alignment of the container connector 731 and the host connector 732. When the distance that the second positioning post 735 extends into the second positioning hole 736 reaches the second preset distance, the first inlet pipe 711 can mate with the second inlet pipe 721, and the first outlet pipe 712 can mate with the second outlet pipe 722.

In some embodiments, the extending directions of the first positioning post 733 and the second positioning post 735 may be parallel to the height direction of the container 50. In some cases, when the extending directions of the first positioning post 733 and the second positioning post 735 are parallel to the height direction of the container 50, the mating direction of the container connector 731 and the host connector 732 can be restricted so that their mating direction is parallel to the height direction of the container 50.

In some embodiments, as shown in FIGS. 8 to 10, the host 60 is further provided with a connector cover assembly 739. The connector cover assembly 739 may include a slider 7391, which can move between a covering position and an open position. When the container 50 mates with the host 60, the slider 7391 can move from the covering position to the open position. When the container 50 separates from the host 60, the slider 7391 can move from the open position to the covering position.

The covering position refers to the position where the slider 7391 can cover the openings of the second inlet pipe 721 and the second outlet pipe 722 located on the host connector 732. Conversely, the open position refers to the position of the slider 7391 when the openings of the second inlet pipe 721 and the second outlet pipe 722 on the host connector 732 are exposed. In this embodiment, when the container connector 731 and the host connector 732 are not mated, the slider 7391 on the host 60 can be in the covering position, covering the openings of the second inlet pipe 721 and the second outlet pipe 722 on the host connector 732. In some embodiments, this can effectively prevent impurities such as dust from entering the host pipe assembly 72 and causing pipe blockage. When the host connector 732 is mated with the container connector 731, the slider 7391 can be controlled to move from the covering position to the open position, thereby exposing the openings of the second inlet pipe 721 and the second outlet pipe 722.

As shown in FIGS. 8 to 10, in some embodiments, the connector cover assembly 739 may include an elastic member 7394, which can provide a biasing force to enable the slider 7391 to move from the open position to the covering position. In this embodiment, when mating the container connector 731 with the host connector 732, a force can be applied to the slider 7391. Under the action of the applied force, the slider 7391 can move from the covering position to the open position, thereby exposing the openings of the second inlet pipe 721 and the second outlet pipe 722 to facilitate mating. During the process of moving from the covering position to the open position, the slider 7391 can compress the elastic member 7394, generating a biasing force. When the container connector 731 and the host connector 732 are mated, the slider 7391 will remain in the open position, and the elastic member 7394 will remain compressed. When it is necessary to separate the host 60 from the container 50, the container connector 731 and the host connector 732 can be directly separated, and the biasing force provided by the elastic member 7394 can cause the slider 7391 to move from the open position to the covering position, covering the openings of the second inlet pipe 721 and the second outlet pipe 722.

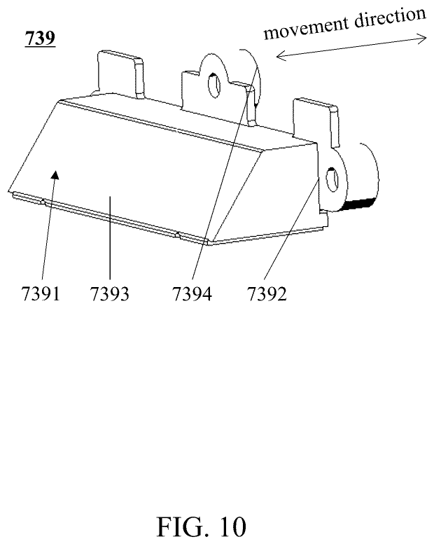

As shown in FIG. 10, in some embodiments, the slider 7391 may include an inclined surface 7393 and a mounting surface 7392 opposite the inclined surface 7393. The elastic member 7394 may be provided on the mounting surface 7392. When thrust is applied along the height direction of the container 50 towards the inclined surface 7393, the slider 7391 can move from the covering position to the open position. When the thrust disappears, the slider 7391 returns to the covering position under the action of the biasing force. In this embodiment, the movement direction of the slider 7391 (as indicated by the arrow in FIG. 10) can be perpendicular to the mounting surface 7392.

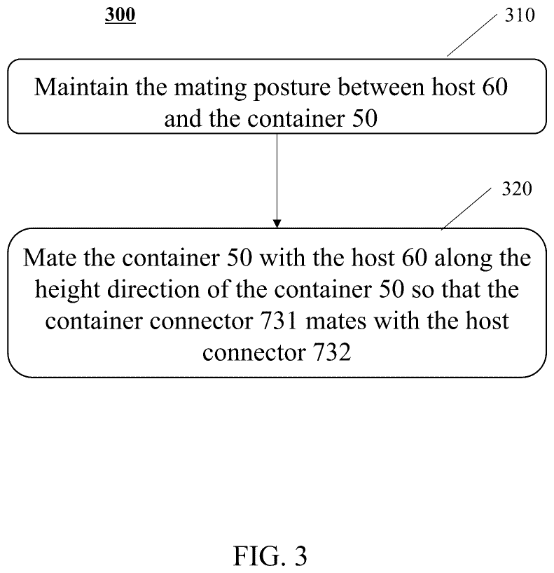

This specification also provides a method for installation operation based on the cooking apparatus 10. Taking FIG. 3 as an illustrative example, in some embodiments, the cooking apparatus 10 may include a container 50 and a host 60. The side wall of the container 50 may be provided with a container connector 731, and the host 60 may be provided with a host connector 732. The installation operation method of the cooking apparatus 10 includes:

Step 310: Maintain the mating posture between the host 60 and the container 50. The mating posture can refer to aligning the mating direction of the host connector 732 and the container connector 731 with the height direction of the container 50. For instant, when the open end of the container 50 is upward along the height direction of the container 50, it can be considered that the container 50 is in a mating state. Similarly, as shown in FIG. 4, when the central axis of the host 60 is perpendicular or approximately perpendicular to the placement plane 90, it can be considered that the host 60 is in a mating state.

Step 320: Mate the container 50 with the host 60 along the height direction of the container 50 so that the container connector 731 mates with the host connector 732.

In some embodiments, before performing Step 320, the positioning post can be mated with the positioning hole along the height direction of the container 50.

Taking FIGS. 8 and 9 as illustrative examples, in some embodiments, the positioning posts may include the first positioning post 733 and the second positioning post 735, and the positioning holes may include the first positioning hole 734 and the second positioning hole 736. The first positioning post 733 may be adapted to the first positioning hole 734, and the second positioning post 735 may be adapted to the second positioning hole 736. In some embodiments, the length of the first positioning post 733 may be greater than that of the second positioning post 735. For more details on the first positioning post 733, the first positioning hole 734, the second positioning post 735, and the second positioning hole 736, refer to the relevant descriptions in FIGS. 8 to 9, which will not be repeated here.

In some embodiments, before performing Step 320, the guide groove 738 can also be mated with the guide post 737 to guide the mating of the positioning post and the positioning hole.

In some embodiments, before performing Step 320, the container 50 and the host 60 can also be brought closer along the height direction of the container 50, so that the slider 7391 moves from the covering position to the open position, thereby exposing the host connector 732 and allowing it to mate with the container connector 731.

The beneficial effects that the cooking apparatus 10 and the installation operation method 300 described in this specification may bring include but are not limited to: (1) By setting the container and the host side by side, the container can directly contact the placement plane, thus lowering the center of gravity of the container and improving the overall stability of the cooking apparatus. In addition, there is no need to move the container above the host when installing or disassembling the cooking apparatus, thereby reducing the difficulty of installation and disassembly; (2) By setting the container and the host side by side, the limitation of the container on the large-sized display screen provided on the host can be reduced, facilitating the use of a larger-sized display screen, which can improve the interactivity between the user and the display screen; (3) When both the container and the host contact the placement plane, the center of the container is not affected by the height of the host, and both the host and the container can provide support simultaneously, enhancing the stability of the container and the host, and reducing the likelihood of tilting or toppling; (4) By setting the display screen at the highest position of the host, on the one hand, it can prevent the display screen from colliding with the container when mating the host with the container. On the other hand, it can prevent the liquid from the container from splashing onto the display screen, which would affect user operation.

The basic concepts have been described above, and it is evident that to those skilled in the art, the above disclosures of the invention are merely examples and do not constitute limitations on this specification. Although not explicitly stated here, those skilled in the art may make various modifications, improvements, and adjustments to this specification. Such modifications, improvements, and adjustments are suggested in this specification, so they still fall within the spirit and scope of the exemplary embodiments of this specification.

Meanwhile, specific terms have been used in this specification to describe the embodiments. Terms such as “an embodiment,” “one embodiment,” and/or “some embodiments” refer to a certain feature, structure, or characteristic that is related to at least one embodiment of this specification. Therefore, it should be emphasized and noted that when “an embodiment,” “one embodiment,” or “an alternative embodiment” is mentioned two or more times at different locations in this specification, it does not necessarily refer to the same embodiment. In addition, certain features, structures, or characteristics in one or more embodiments of this specification can be appropriately combined.

Furthermore, it is understood by those skilled in the art that various aspects of this specification can be explained and described through several potentially patentable categories or situations, including any new and useful process, machine, combination of products or materials, or any new and useful improvement thereof. Accordingly, various aspects of this specification can be implemented entirely in hardware, entirely in software (including firmware, resident software, microcode, etc.), or in a combination of hardware and software. The above hardware or software may be referred to as a “data block,” “module,” “engine,” “unit,” “component,” or “system.” Moreover, various aspects of this specification may manifest as computer products located on one or more computer-readable media, which include computer-readable program code.

Additionally, unless explicitly stated in the claims, the sequence of processing elements and steps, the use of numeric letters, or other naming conventions in this specification are not intended to limit the order of processes and methods in this specification. While the above disclosure discusses some embodiments currently considered useful through various examples, it should be understood that such details are for illustrative purposes only, and the appended claims are not limited to the disclosed embodiments. On the contrary, the claims are intended to cover all modifications and equivalent combinations that fall within the spirit and scope of the embodiments of this specification. For instance, although the system components described above may be implemented via hardware devices, they may also be realized purely through software solutions, such as installing the described system on existing servers or mobile devices.

Similarly, it should be noted that, to simplify the presentation disclosed in this specification and assist in understanding one or more embodiments of the invention, multiple features are sometimes incorporated into a single embodiment, figure, or description of the same in the previous description of this specification's embodiments. However, this disclosure method does not imply that the object of this specification requires more features than those mentioned in the claims. In fact, the features of the embodiments are less than all of the features of the single embodiment disclosed above.

Numbers describing components or attribute quantities are used in some embodiments, and it should be understood that such numbers, used in the description of embodiments, are sometimes modified by words like “approximately,” “about,” or “substantially.” Unless otherwise stated, “approximately,” “about,” or “substantially” indicates a variation of ±20% of the given number. Accordingly, in some embodiments, numerical data used in the specification and claims are approximate values, which may change based on the characteristics required for individual embodiments. In some embodiments, numerical data should be considered with defined significant figures and employ standard rounding methods. Although numerical ranges and data used in some embodiments of this specification are approximate to confirm the breadth of their scope, the setting of such values in specific embodiments is as precise as feasible within practical limits.

Finally, it should be understood that the embodiments described in this specification are only used to illustrate the principles of the embodiments of this specification. Other modifications may also fall within the scope of this specification. Therefore, by way of example rather than limitation, alternative configurations of the embodiments of this specification can be considered consistent with the teachings of this specification. Accordingly, the embodiments of this specification are not limited to the embodiments explicitly presented and described herein.

1. A cooking apparatus, comprising a host and a container; wherein the host is defined outside the container, and the host and the container are arranged side by side on a placement plane, a bottom surface of the host and a bottom surface of the container both contact the placement plane.

2. The cooking apparatus according to claim 1, wherein an inlet and an outlet of the container are defined on a same side wall of the container, and the host is disposed on the same side wall.

3. The cooking apparatus according to claim 1, wherein a height of the host is greater than a height of the container.

4. The cooking apparatus according to claim 1, wherein a value range of a ratio between a length of a long side of the host and a length of a long side of the container is from 0.3 to 0.8.

5. The cooking apparatus according to claim 1, wherein the container comprises a liquid inlet and outlet component, and the host comprises a host pipe assembly; when the liquid inlet and outlet component mates with the host pipe assembly, a passage can be formed for liquid to flow between the host and the container.

6. The cooking apparatus according to claim 5, wherein the liquid inlet and outlet component comprises a first inlet pipe and a first outlet pipe, and the first inlet pipe and the first outlet pipe are respectively connected to an inlet and an outlet of the container; the host pipe assembly comprises a second inlet pipe and a second outlet pipe, wherein the second inlet pipe is capable of communicating with the first inlet pipe, and the second outlet pipe is capable of communicating with the first outlet pipe, and the second outlet pipe is capable of communicating with the second inlet pipe.

7. The cooking apparatus according to claim 6, wherein at least a part of the first inlet pipe and the second inlet pipe is located above a maximum water level line of the container and is close to a first docking port; at least a part of the first outlet pipe and the second outlet pipe is located above the maximum water level line of the container and is close to the second docking port.

8. The cooking apparatus according to claim 6, wherein the host further comprises a heating assembly, and the heating assembly is used to heat liquid in the host pipe assembly.

9. The cooking apparatus according to claim 1, further comprising a display screen, wherein in a height direction of the container, a lowest point of the display screen is higher than a highest point of the container.

10. The cooking apparatus according to claim 9, wherein in the height direction of the container, a side wall of the container close to the display screen does not overlap with a side wall of the display screen close to the container.

11. The cooking apparatus according to claim 9, wherein an angle between a plane of the display screen and the placement plane is in a range of 30 degrees to 60degrees.

12. The cooking apparatus according to claim 6, wherein the liquid inlet and outlet component comprises a container connector, the container connector is provided with the first inlet pipe and the first outlet pipe; the host pipe assembly comprises a host connector, and the host connector is provided with the second inlet pipe and the second outlet pipe; first inlet pipe and the second inlet pipe are in communication, and the first outlet pipe and the second outlet pipe are in communication, when the host connector and the container connector mate.

13. The cooking apparatus according to claim 12, wherein the container connector is provided with two first positioning posts, and the two first positioning posts are respectively disposed on an outside of the first inlet pipe and the first outlet pipe; the host connector is provided with two first positioning holes, and the first positioning posts are adapted to the first positioning holes, and the two first positioning holes are respectively defined on an outside of the second inlet pipe and the second outlet pipe; when the first positioning posts extend into the first positioning holes to a first preset distance, the host connector and the container connector mate.

14. The cooking apparatus according to claim 12, wherein the container connector is provided with a second positioning post, the second positioning post is defined between the first inlet pipe and the first outlet pipe, and a length of the first positioning post is greater than a length of the second positioning post;
the host connector is provided with a second positioning hole, and the second positioning post is adapted to the second positioning hole, the second positioning hole is defined between the second inlet pipe and the second outlet pipe; when the second positioning post extends into the second positioning hole to a second preset distance, the container connector and the host connector mate.

15. The cooking apparatus according to claim 12, wherein the host is further provided with a connector cover assembly, the connector cover assembly comprising: a slider, which is capable of moving between a covering position and an open position; the slider moves from the covering position to the open position when the container mates with the host, and the slider moves from the open position to the covering position when the container is separated from the host.

16. The cooking apparatus according to claim 15, wherein the connector cover assembly comprises an elastic member, which is used to provide biasing force so that the slider can move from the open position to the covering position;
wherein the slider comprises an inclined surface and a mounting surface opposite the inclined surface, and the elastic member is provided on the mounting surface; the slider moves from the covering position to the open position when thrust is applied along the height direction of the container towards the inclined surface; the slider returns to the covering position under the action of the biasing force when the thrust disappears

17. A cooking apparatus, comprising a host and a container; wherein the host is defined outside the container, and a bottom surface of the host and a bottom surface of the container both contact a placement plane.

18. The cooking apparatus according to claim 17, wherein the inlet and outlet of the container are disposed on the same side wall of the container, and the host is disposed on the same side wall.

19. The cooking apparatus according to claim 17, wherein the container comprises a liquid inlet and outlet component, and the host comprises a host pipe assembly; a passage is formed for the liquid to flow between the host and the container when the liquid inlet and outlet component mates with the host pipe assembly.

20. The cooking apparatus according to claim 17, wherein the liquid inlet and outlet component comprises a first inlet pipe and a first outlet pipe, and the first inlet pipe and the first outlet pipe are respectively connected to the inlet and outlet of the container; the host pipe assembly comprises a second inlet pipe and a second outlet pipe, wherein the second inlet pipe can communicate with the first inlet pipe, and the second outlet pipe can communicate with the first outlet pipe, and the second outlet pipe communicates with the second inlet pipe.
